(19) United States
(12) Patent Application Publication
(10) Pub. No.: US 2010/0325939 A1
(43) Pub. Date: Dec. 30, 2010

(54) Non-releasable Line Fastening Device

(76) Inventor: Ryan Christopher Frayne, Tampa, FL (US)

Correspondence Address: Ryan C Frayne, 14008 Middleton Way, Tampa, FL, 33624, US

(21) Appl. No.: 12/636,738

(22) Filed: Dec. 12, 2009

Related U.S. Application Data
(60) Provisional application No. 61/122,374, filed on Dec. 13, 2008.

(51) Int. Cl. A01K 91/04; F16G 11/00; A01K 83/00

(52) U.S. Cl. 43/44.83; 24/129 R; 24/131 R

(57) ABSTRACT

A line fastening device (100), capable of irreversibly attaching to a line, without tying any knots. The device comprises of a line enclosure (104) and an elongated member (102). The elongated member (102) provides a structure to which a line (308) may be wrapped around. The line enclosure (104) is comprised of an interior retaining structure (106) and exterior guard (110). The opening of the line enclosure (112) is defined by the space between the interior retaining structure (106) and exterior guard (110). This opening (112) allows a line (308) to pass inside of the line enclosure (104) without access to either ends of the line. When a line (308), that has been wrapped around the line itself and the elongated member (102), is pulled through the line enclosure's opening (104) and past the end of the retaining structure (108), the line (308) will be unable to exit the line enclosure (104).

### CROSS-REFERENCES TO RELATED APPLICATIONS

This application claims the benefit of provisional patent application Ser. No. 61/122,374, filed 2008 Dec. 13 by the present inventor.

### FEDERALLY SPONSORED RESEARCH

Not Applicable.

### SEQUENCE LISTING OR PROGRAM

Not Applicable.

### BACKGROUND OF THE INVENTION

1. Field of Invention

This invention generally relates to line fastening devices, specifically to such devices used in applications that require very secure line attachment, such as fishing.

2. Prior Art

Generally, a line is only as useful as the chosen method of attachment permits. In many cases, that method of attachment is some type of knot. In situations where the line will remain static, and minimal force will be applied to the line, a simple overhand knot will suffice. However, in more demanding situations, complex knots must be used to overcome pulling forces that would otherwise pull a simple knot apart and cause the attached object to become untied.

In the case if fishing, as a fish attempts to escape capture it will violently pull on the line in one direction, while the angler vigorously pulls in the opposite direction, as he or she attempts to land the fish. This sort of “tug of war” that occurs during fishing is the reason fisherman must use complex knot tying methods to securely fasten terminal tackle to the end of a fishing line. However, the complexity of these knot tying methods makes learning and remembering such methods difficult. Further, even if a person knows the steps required to tie a knot, tying a complex knot may still be difficult due to poor eye sight or poor hand dexterity.

The sport of fishing also creates additional problems that make knot tying even more challenging. When fishing during poor weather or on a rocking boat, something as simple as threading the end of your fishing line through the eye of a fishing hook, can prove to be difficult. The need to pass the line between hands during tying, further adds to the difficulty and frustration of tying a knot at sea.

Additionally, fishing also requires an angler to retie these complex knots, when replacing or switching between tackle. To make switching between tackle faster, several types of snaps and clips have been invented such as the invention shown in U.S. Pat. No. 54,684 (1866) to Chapman. Snaps such as the invention disclosed by Chapman allow an angler to switch between different types of terminal tackle without the need to retie a knot each time.

However, releasable attachment devices such as Chapman's, still require using a complex knot to initially attach the device to the line. Therefore, such devices are still only as secure as the knot used to attach them. If the knot securing the device to the line fails, the entire rigging, including the releasable attachment device, will be lost. By their very nature; snaps, clips, and other releasable attachment devices, can release or detach from the object they were securing, even if the line does not break. Using such devices requires giving up security and dependability for only a moderate improvement in convince.

Though none of the prior art show devices that are capable of non-releasable line attachment, prior art does exist which disclose devices which attach without knot tying.

U.S. Pat. No. 5,537,776 (1996) to Gillard shows a hook with a spiraling upper shank and open eyelet. The disadvantage of this invention is that the method of attachment is just as complicated and also less secure than tying a fishing knot. Unlike a fishing knot, this invention can easily be untied. Further, the use of a spiraling upper shank limits the compactness of the design.

U.S. Pat. No. 4,905,403 (1990) to Manno shows a fish hook whose upper shank has been bent into a sideways ‘S’ shape and whose top consist of an open loop. The open loop design does not prevent a line from exiting the open loop, once entered. If the fish hook is shaken, the line can slip out of the open loop, thereby allowing the line to unravel from the shank and prematurely detach from the fish hook. As is the case with all prior art, Manno's fishhook unties with the same ease it took to tie. Further, the ‘S’ shaped bend makes the shank bulky, which prohibits the user from pushing the shank into the bait; a method of baiting used to conceal the shank of the hook.

U.S. Pat. No. 3,848,354 (1974) to Austad shows a quick tie device comprising of a shank, a post extending perpendicularly from the shank, and an open eyelet. The tying method described in the patent is effective; however, to get the line inside of the eyelet, the user must force the line into the gap between the eyelet and shank. This chafes the line making it more susceptible to breaking In U.S. Pat. No. 5,009,025 (1991), Austad replaces the open eyelet with a helix. Though this eliminates the aforementioned chafing problem, now the line is even less secure. If the end of the helix catches the line; as can happen if a fish is thrashing, the line will slide around the helix and subsequently detach from the hook. Further, both of Austad's quick tie devices are more cumbersome than a standard hook or lure equipped with a standard eyelet.

U.S. Pat. No. 5,881,491 (1999) to Kira shows a fish hook whose shank has a flattened joint, with a slot leading to a hole. To fasten the hook to a line, the user slips the line into the slot, wraps the line around the shank, and then slips the line back into the slot. The hook described by the patent is as compact as a standard hook; however, if the width of the slot is the same as the diameter of the line being used, than the line can easily slide out of the slot, thereby detaching the hook from the line. If the width of the slot is smaller than the diameter of the line being used, than the line will chafe as it is pushed into the slot; thereby weakening the line.

U.S. Pat. No. 6,959,470 (2005) to Kuslich shows “an apparatus for releasably securing a line”. By the inventions own admission, the apparatus was designed to allow the line to easily become untied or detached from the line, without cutting the line. In applications where premature detachment cannot be risked, such a device would be impractical. In applications such as fishing, where it is common for the line to be violently shaken, the line's premature detachment is inevitable.

Without the ability prevent the line from untying during use, the inventions disclosed in the prior art fail to be relevant to the fields of safety, climbing, fishing, and other demanding applications.

### SUMMARY OF THE INVENTION

This disclosure describes various embodiments of a non-releasable line fastening device capable of irreversibly attaching to a line, without the use of any knots. Unlike the prior art, the present invention is non-releasable; meaning that once tied, the line cannot become untied while in use.

The present invention comprises of a line enclosure and an elongated member. The elongated member provides a structure to which a line may be wrapped around. The line enclosure has an interior retaining structure with at least one open end and an exterior guard with zero or more open ends. The opening of the line enclosure is defined by the space between the interior retaining structure and exterior guard. This opening allows a line to pass inside of the line enclosure without access to either ends of the line. When a line, which has been affixed to the elongated member, is pulled through the line enclosure's opening, the line will be unable to exit the line enclosure.

When a portion of a line is held adjacent to the elongated member, passed inside of the line enclosure and then wrapped around the elongated member and the line itself; a portion of the line will consequently be affixed to the elongated member. To prevent the line from unwrapping, the line is once again passed into the line enclosure; thereby nonreleasebly fastening the line to the device.

In one embodiment of the present invention the line enclosure's opening is made larger than the cross sectional thickness of the line.

In another embodiment of the present invention, the line enclosure's opening is made smaller than the cross sectional thickness of the line. The line enclosure is made from a flexible material so that it flexes as the line is pulled through the line enclosure's opening.

In another embodiment of the present invention, the line enclosure is directly attached, approximately perpendicular to a given object. The area of connection where the line enclosure comes into contact with the object, provide a structure to which a line may be wrapped around, thereby substituting as the elongated member.

### SUMMARY OF THE INVENTION

### Objects and Advantages

Accordingly, in addition to the objects and advantages of the non-releasable line fastening device described in my above patent, several objects and advantages of the present invention are:

(a) to provide a non-releasable fastening device that irreversibly fastens to a line, thereby remaining securely fastened even if the line or device is violently shaken or pulled from any direction;

(b) to provide a non-releasable fastening device to which a line can be fastened without the use of any knots;

(c) to provide a non-releasable fastening device whose tying method is simple to learn and easy to remember;

(d) to provide a non-releasable fastening device whose tying method is easy to perform, even for those with poor eyesight or poor hand dexterity;

(e) to provide a non-releasable fastening device that attaches to a line without pinching or chafing the line, thereby maintaining the reliability of the line;

(f) to provide a non-releasable fastening device which does not require the line to be thread into an eyelet or opening;

(g) to provide a non-releasable fastening device which is compact, only occupying an area slightly larger than that of a traditional eyelet;

(h) to provide a non-releasable fastening device that can be attached without accessing either ends of a line, thereby allowing for attachment of the device in the middle of a line, as well as to the ends of a line;

(i) to provide a non-releasable fastening device which can be manufactured out of a single piece of wire, thereby making manufacturing as economical as traditional eyelets;

(j) to provide a non-releasable fastening device that can attach to a variety of different line types, including but not limited to monofilament, microfilament, fluorocarbon and braided line.

(k) to provide a non-releasable fastening device than can be scaled up or down to accommodate lines of any size diameters.

Another object and advantage of the present invention is to provide a non-releasable fastening device whose attachment means are not dependent upon the line's thickness—in other words, the device has no minimum line diameter. This means that a single non-releasable fastening device, made to accommodate a thick, twenty pound monofilament line, will work just as effectively with a thinner eight pound braided fishing line.

Further objects and advantages of the present invention will become apparent from a consideration of the drawings and ensuing description.

### BRIEF DESCRIPTION OF THE DRAWINGS

FIGS. 1A and 1B shows a perspective view and side view of the preferred embodiment of the present invention, wherein the present invention is made from a single piece and the elongated member is contiguous to the end of the exterior guard.

FIGS. 2A, 2B, and 2C shows an isometric view, top view, and bottom view of another embodiment of the present invention, wherein the present invention is made from a single piece and the elongated member is contiguous to the interior line retaining structure.

FIGS. 3A to 3F show the preferred method of attaching a line to the present invention, wherein the line is wrapped clockwise around the elongated member.

FIGS. 4D and 4F show alternative steps for attaching a line to the present invention, wherein the line is wrapped counterclockwise around the elongated member.

FIGS. 5A and 5B show an alternative method of attachment, wherein the present invention is used to indirectly attach a line to an object by securely fastening the ends of looped line.

FIG. 6A show an isometric view of the present invention; with the elongated member lying horizontally, during the final step of the preferred attachment method.

FIG. 6B shows a front view of the present invention, after the preferred attachment method has been completed.

FIG. 7 shows an isometric view of another embodiment of the present invention, wherein the elongated member and line enclosure have be made separately and then joined together.

FIG. 8 shows an isometric view of another embodiment the present invention, wherein there is a gap in the exterior guard, making the device releasable.

FIG. 9A shows a front view of another embodiment of the present invention, wherein the line enclosure is flat and made from a flexible material, with minimal space between the end of the retaining structure and exterior guard.

FIG. 9B shows another version of the embodiment of the present invention, shown in FIG. 9A, with a space between the end of the retaining structure and exterior guard.

FIG. 10A shows a front view of another embodiment of the present invention, wherein the elongated member is approximately tangent to the line enclosure and there is bulge along the elongated member.

FIG. 10B shows a front view of the embodiment of the present invention, shown in FIG. 10B, with the elongated member cutoff just below the bulge.

FIG. 11 shows an embodiment of the present invention attached to the nose of a fishing lure.

FIGS. 12A and 12B shows an embodiment of the present invention integrated into a barrel swivel.

FIG. 13 shows an embodiment of the present invention integrated into an interlock clip.

FIG. 14 shows an embodiment of the present invention integrated into a snap.

FIGS. 15A and 15B shows a top and side view; respectively, of an embodiment of the present invention with a split ring attached to the end of the elongated member, opposite the line enclosure.

FIG. 16 shows an isometric view of a fishhook integrating the present invention into the end of the elongated member, opposite the fishhook's point.

FIG. 17A shows an elevational view of the present invention integrated into a fishhook; with the line enclosure tilting upright away from the fishhook's point.

FIG. 17B shows an elevational view of a fishhook using the present invention; with the line enclosure tilted down toward the fishhook's point.

FIG. 17C shows an elevational view of a fishhook using the present invention; with the line enclosure facing down, opposite the side of the fishhook's point.

DRAWING -- Reference Numerals

100 non-releasable line fastening device
102 elongated member
104 line enclosure
106 interior retaining structure
108 end of the retaining structure
110 exterior guard
112 line enclosure's opening
202 end of the exterior guard
302 static hand
304 guide hand
306 end of line
308 line
310 standing end of line
312 vertical wrapping
502 loop
504 end of loop
506 eyelet
802 gap in exterior guard
810 line stop
812 notch
820 bulge
900 body of fish lure
910 swivel
912 loop eyelet
930 interlock snap
950 split ring
960 fishhook's point

### DETAILED DESCRIPTION OF INVENTION

In the following description, for the purpose of explanation, numerous specific details are set forth in order to provide a thorough understanding of the present disclosure. However, it will be apparent to one skilled in the art that the present invention may be practiced without these specific details.

The present invention comprises of a very unique line enclosure and an elongated member. The unique line enclosure comprise of an interior retaining structure and an exterior guard. All or part of the interior retaining structure must be surrounded by the exterior guard. The elongated member may be any structure that a line may be wrapped around.

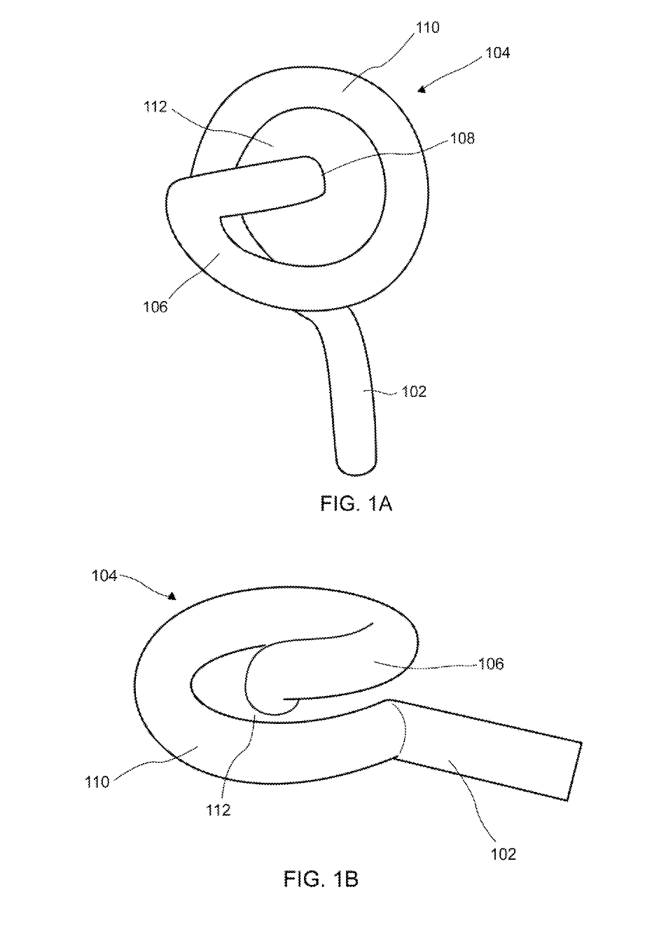

FIGS. 1A and 1B shows an embodiment of the non-releasable line fastening device 100, made from a single piece of cylindrically-shaped material, such as wire. The line enclosure 104; comprising of the exterior guard 110 and interior retaining structure 106, is located at one end of the elongated member 102. The end of the retaining structure 108 is angled downward, so that it is below part of the exterior guard 110. The space between the exterior guard 110 and interior retaining structure 106 is the line enclosure's opening 112.

The embodiment show in FIGS. 1A and 1B has very simple and gradual curves and bends. The lack of tight or complex bends makes it easy to manufacture. Further, because of the way in which the elongated member is connected to the line enclosure, a line can pass into the exterior guard 110 without access to either ends of the line. In this manner, the embodiment shown in FIGS. 1A and 1B can also serve as a “no thread” eyelet, giving the user the option of tying a knot to the exterior guard 110 without needing to thread either end of the line. Of course, tying a knot to the exterior guard 110 would still suffer from many of the deficiencies that come with tying any knot (see BACKGROUND OF THE INVENTION). For this reason, a much preferable, knotless method of attachment that also requires no threading is disclosed latter in this section.

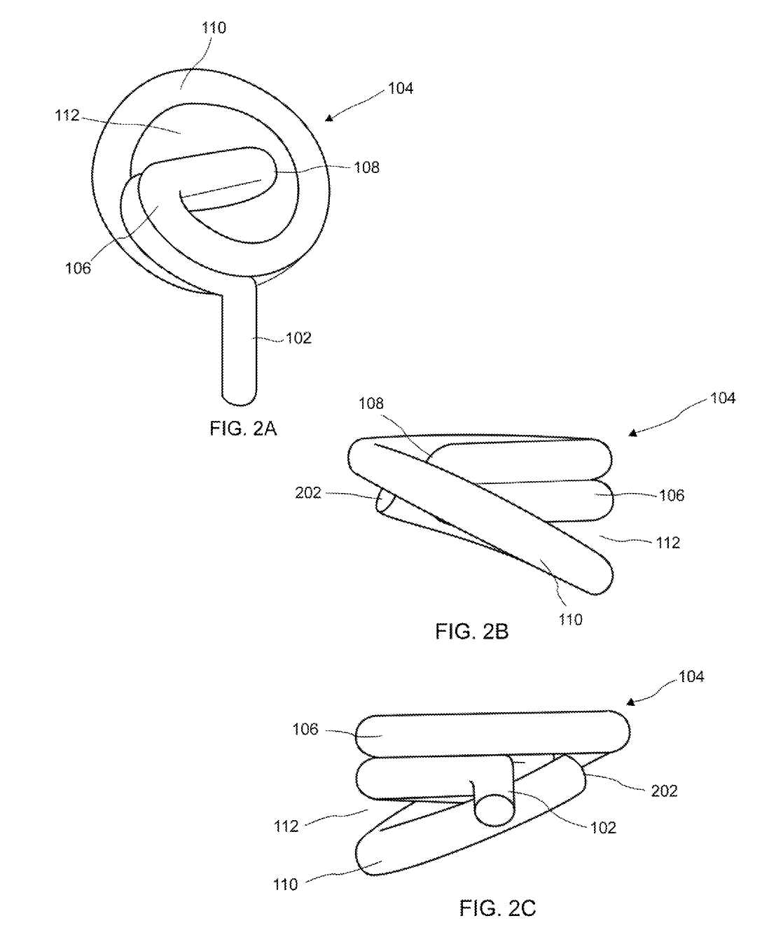

FIG. 2A to 2C shows another embodiment of the non-releasable line fastening device 100, also made from a single piece of cylindrically-shaped material. Just as in the aforementioned embodiment, the line enclosure 104 is located at one of the ends of the elongated member 102. Unlike the previous embodiment, the interior retaining structure 106 is the part of the line enclosure 104 that is connected to the elongated member 102. The end of the retaining structure 108 is angled downward, so that it is below part of the exterior guard 110. Best seen in FIGS. 2B and 2C, the end of the exterior guard 202 curves back towards itself, so that it is touching the underside of the exterior guard 110. The space between the exterior guard 110 and interior retaining structure 106 define the line enclosure's opening 112.

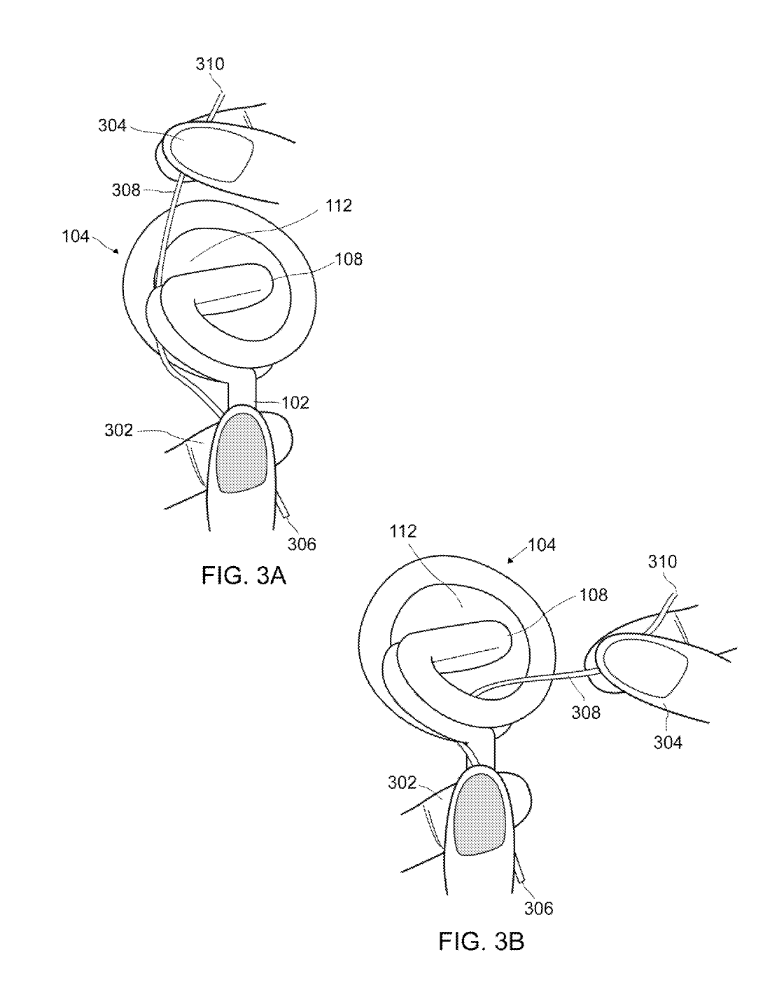

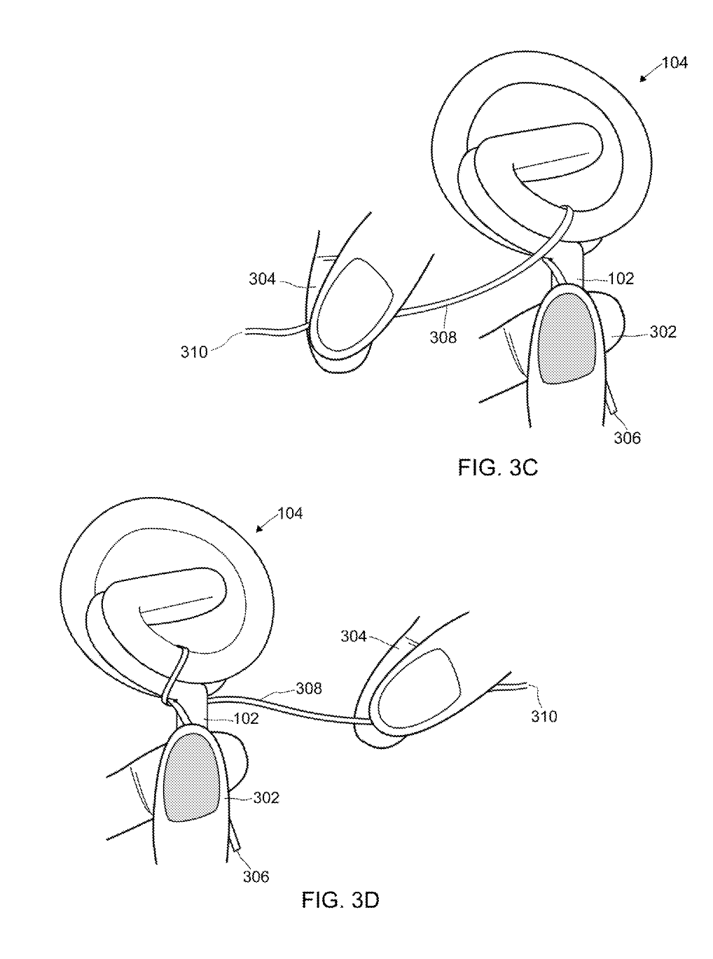

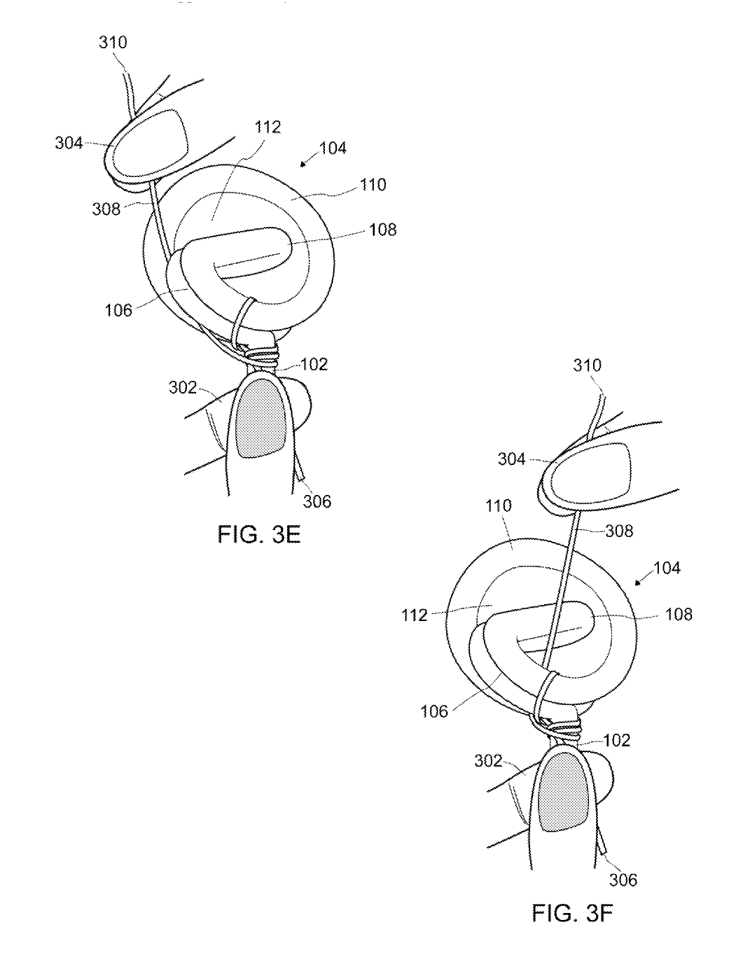

FIG. 3A to 3E show the preferred method of attaching a line 308 to the non-releasable line fastening device 100. During the line tying method, the end of the line 306 is held against the elongated member 102 with the user's static hand 302. The static hand 302 remains holding the end of the line 306 against the elongated member 102 until the tying is completed. The guide hand 304 is used to guide the line 308 through the procedures below.

Step 1—Guide the line 308 into the line enclosure 104. As shown in FIG. 3A, the line 308 is guided into the line enclosure's opening 112. Shown in FIG. 3B, the line 308 is then pulled through the line enclosure's opening 112 until the line has been pulled past the end of the retaining structure 108.

Step 2—Wrap the line 308 clockwise, around the elongated member 102 and the end of the line 306, a plurality of times. Shown in FIG. 3C, the line 308 is pulled downward, towards the elongated member 102. Shown in FIG. 3D, the line 308 is wrapped around the end of the line 306 and elongated member 102 one or more times; following a clockwise rotation for each wrap.

Step 3—Guide the line 308 back into the line enclosure 104. Shown in FIG. 3E; after wrapping the line around the elongated member 102 one or more times, the line 308 is guided into the line enclosure's opening 112. As shown in FIG. 3F, the line 308 is then pulled through the line enclosure's opening 112 until the line has been pulled past the end of the retaining structure 108.

As an optional final step, while firmly holding the elongated member 102, the user can pull on the standing end of the line 310 to tighten the connection and verify that the line 308 is securely fastened.

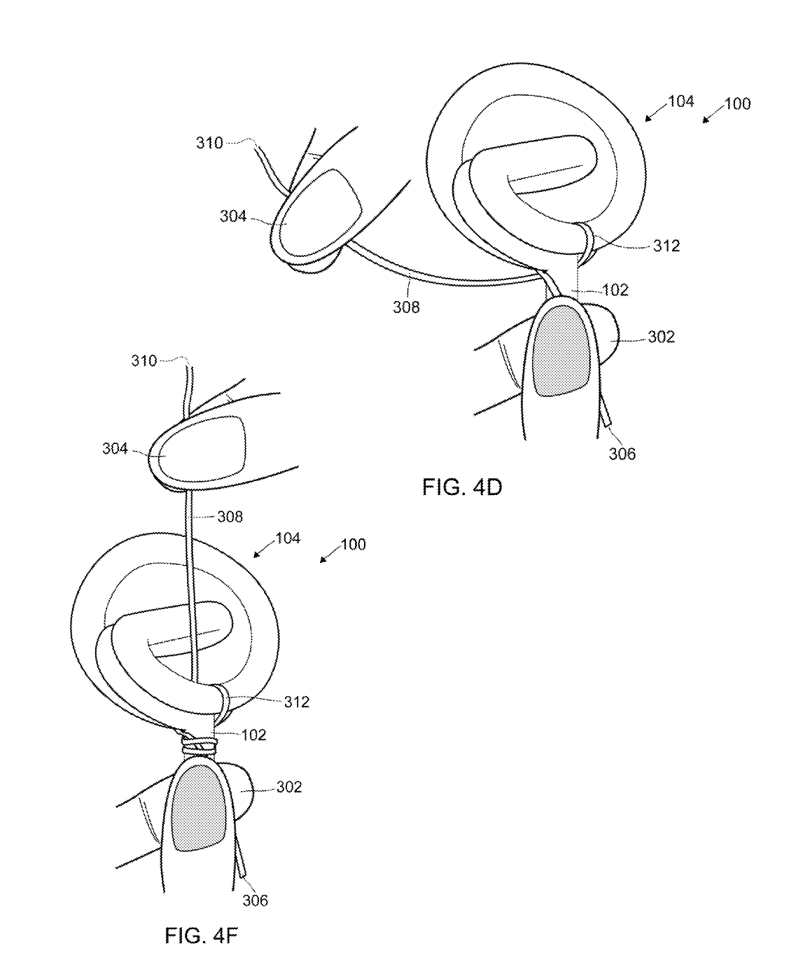

An alternative line fastening method is to wrap the line 308 counter-clockwise around the elongated member 102 and end of the line 306, a plurality of times. Other than the direction in which the line 308 is wrapped, the tying method is the same as the other attachment method described above. As shown in FIG. 4D, when the line 308 is wrapped counter-clockwise around the elongated member 102, the vertical wrapping 312 moves to the right of the elongated member 102 (rather than resting on the left side of the elongated member 102 as shown in FIG. 3D). As shown in FIG. 4F, because the vertical wrapping 312 is out of the way of the line 308, the line 308 hangs closer to the elongated member 102. This allows the non-releasable line fastening device 100 to hang on the line 308 more naturally (straighter); which can be of importance in fishing.

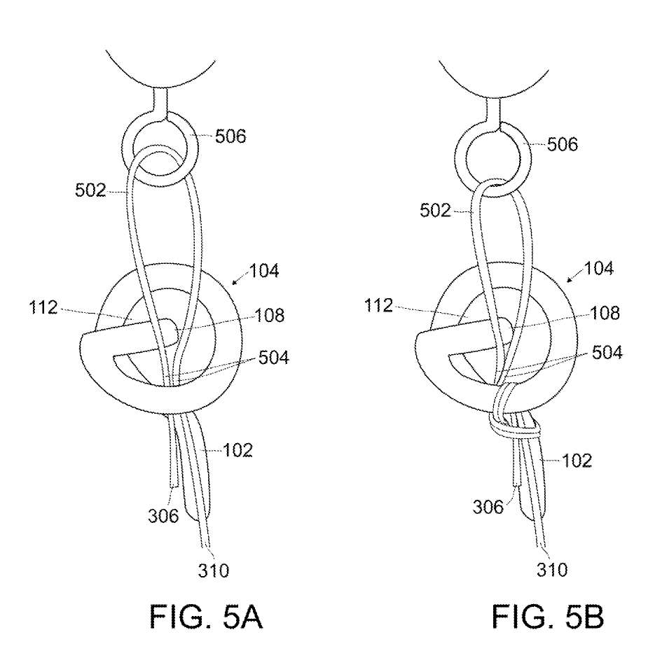

Another alternative line fastening method allows the user to tie a loop to an object, using the non-releasable line fastening device to securely close the open end of the loop. Shown in FIG. 5A, the end of the line 306 is thread into the eyelet 506 and pulled through to form a loop 502 with an open end. Also shown in FIG. 5A, the end of the loop 504 is pulled through the line enclosure's opening 112 until both parts of the loop 502 are past the end of the retaining structure 108. The end of the loop 504 is then wrapped clockwise (or counterclockwise) around the end of the line 306, standing end of the line 310, and elongated member 102. The final step is to once again pull the end of the loop 504 through the line enclosure's opening 112 until the end of the loop 504 is past the end of the retaining structure 108; shown completed in FIG. 5B.

It will be obvious to those skilled in the art that the aforementioned attachment method can also be used for securing the loop to objects without eyelets as well. Additionally, the non-releasable attachment device can also be used to form a loop when oriented in the opposite direction; with the end of the elongated member pointed toward the loop.

Another alternative line fastening method is to attach the line enclosure portion of the present invention directly to an eyelet. The eyelet is connected to the line enclose by threading the eyelet onto the elongated member and up the elongated member until inside the line enclosure. Then, with the eyelet in the line enclosure, a line is attached to the non-releasable line fastening device, as shown in FIGS. 3A to 3F. Once the attachment steps have been completed the user can choose to trim the excess length of the elongated member. This method of attachment will only work with embodiments of the present invention, where the elongated member 102 is connected to the end of the exterior guard 110; as shown in FIGS. 1A and 1B.

Regardless of the attachment method used, the attachment relies upon the present invention's unique ability to “lock” the line into the line enclosure. Wrapping the line around itself and the elongated member secures a potion of the line to the elongated member. After the line is “locked” inside the line enclosure, the line that is wrapped around the shank cannot unravel.

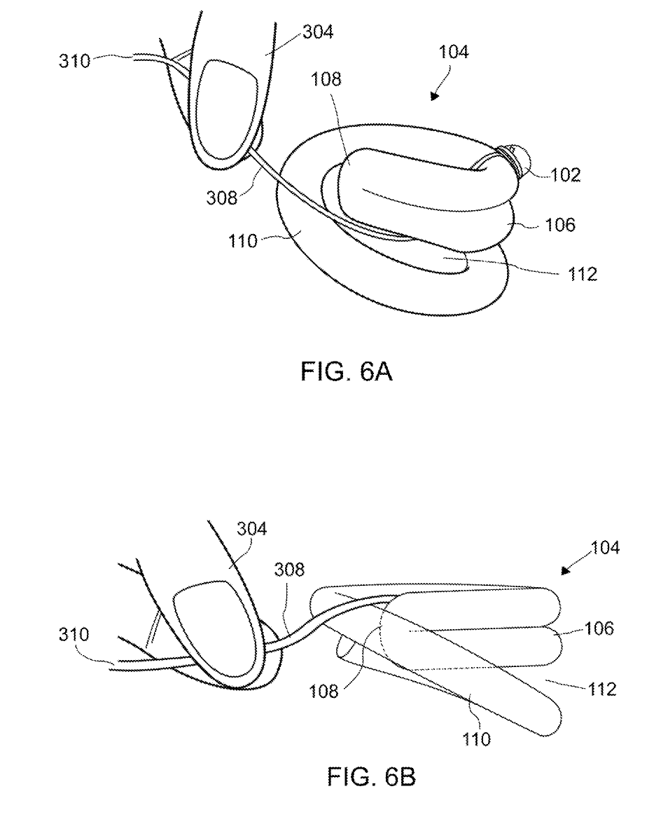

Shown in FIG. 6A, a line 308 that has been attached to the elongated member 102, enters the line enclosure 104 by passing below the interior retaining structure 106. When the line 308 is pulled past the end of the retaining structure 108, the pulling action (and the line's own weight) causes the line 308 to straighten out, thereby causing the portion of the line inside of the enclosure to rise above the end of the retaining structure 108. As Shown in FIG. 6B, once the line 308 has straightened out, the exterior guard 110 prevents the line from passing under the end of the retaining structure 108; thereby “locking” the line 308 inside of the line enclosure 104. Even without tension on the line 308, the exterior guard 110 prevents the line 308 from dropping below the end of the retaining structure 108.

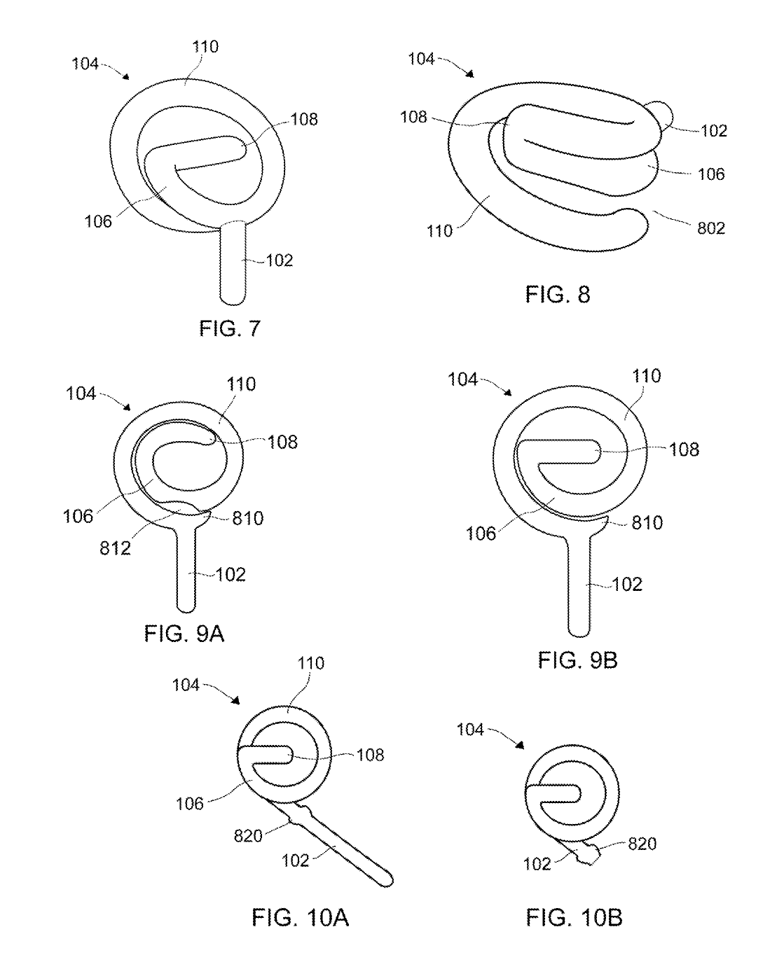

FIG. 7 shows an embodiment of present invention where the elongated member 102 and line enclosure 104 are made individually, and then joined together. The elongated member 102 could be attached to the line enclosure 104 using a variety of techniques such as soldering, brazing, welding, adhesives, etc.

FIG. 8 shows another embodiment of the present invention, in which there is a gap in the exterior guard 802. This gap 802 allows the user to easily untie the line, thereby making it a releasable line fastening device. Of course, making this embodiment releasable makes it less secure than the other embodiments. And the larger the gap (and the closer the gap is to the front of the line enclosure) the easier the embodiment is to unite and the less secure it becomes.

FIG. 9A shows another embodiment of the present invention, where the interior retaining structure 106 and exterior guard 110 do not overlap and are on the same plan (i.e. the line enclosure 104 is flat). Made from a flexible springy material such as plastic, the retaining structure can be temporarily bent upward to create an opening between the interior retaining structure 106 and exterior guard 110. The line (not shown) is then pulled through the opening, until it has passed the end of the retaining structure. The line enclosure 104 will automatically spring back to its original flat shape, thereby closing the opening. The notch 812 just above the elongated member 102 lets the line enclosure 104 remain completely flat, even with a line inside. The line stop 810 prevents the line wrapped around the elongated member 102, from sliding up the elongated member 102 and into the notch 812.

As shown in FIG. 9B, the aforementioned “flat” embodiment, shown in FIG. 9A, can also be made without a notch or line stop. FIG. 9B also has a space between the end of the retaining structure 108 and exterior guard 110 even when the line enclosure 104 is flat.

FIG. 10A shows another embodiment of the present invention, with the elongated member 102 attached to the end of the exterior guard 110 and angled tangent to the line enclosure 104. To reduce the size of the device, after attaching a line, the user can cutoff the elongated member 102, just below the bulge 820 (as shown in FIG. 10B without a line attached). The bulge 820 is used to indicate where to cut and prevents the line from sliding off the end of the elongated member 102, after trimming.

The non-releasable line fastening device can be used for many applications, in many cases as a replacement to “traditional” ring-shaped eyelets. With regards to fishing, the present invention can be used on many types of terminal tackle including lures, hooks, jigs, flies, swivels, snaps, interlock snaps, split rings, etc.

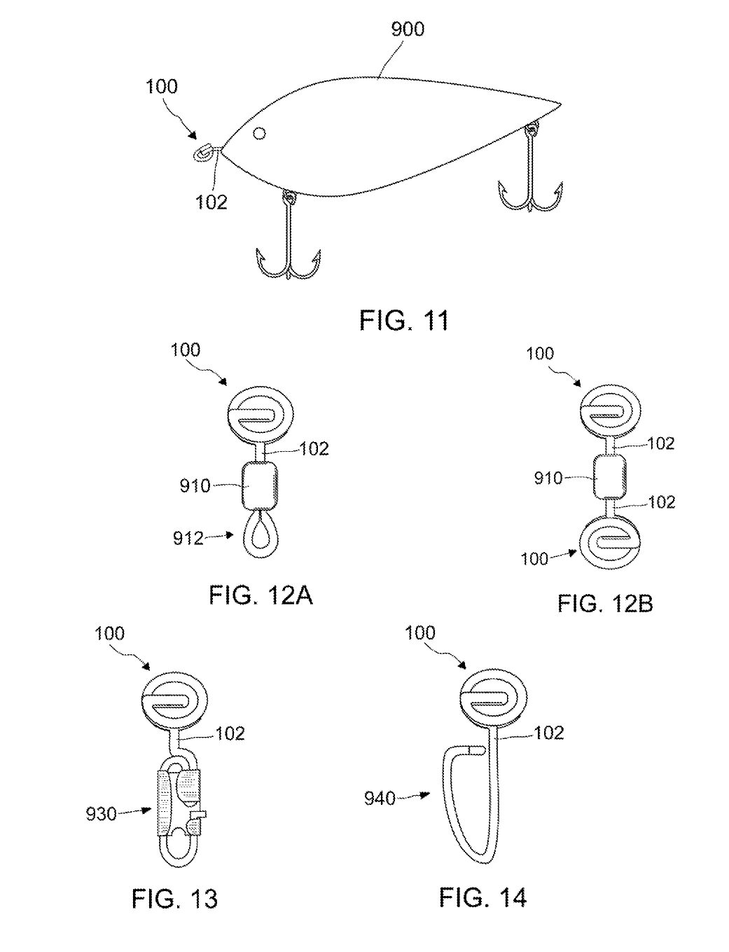

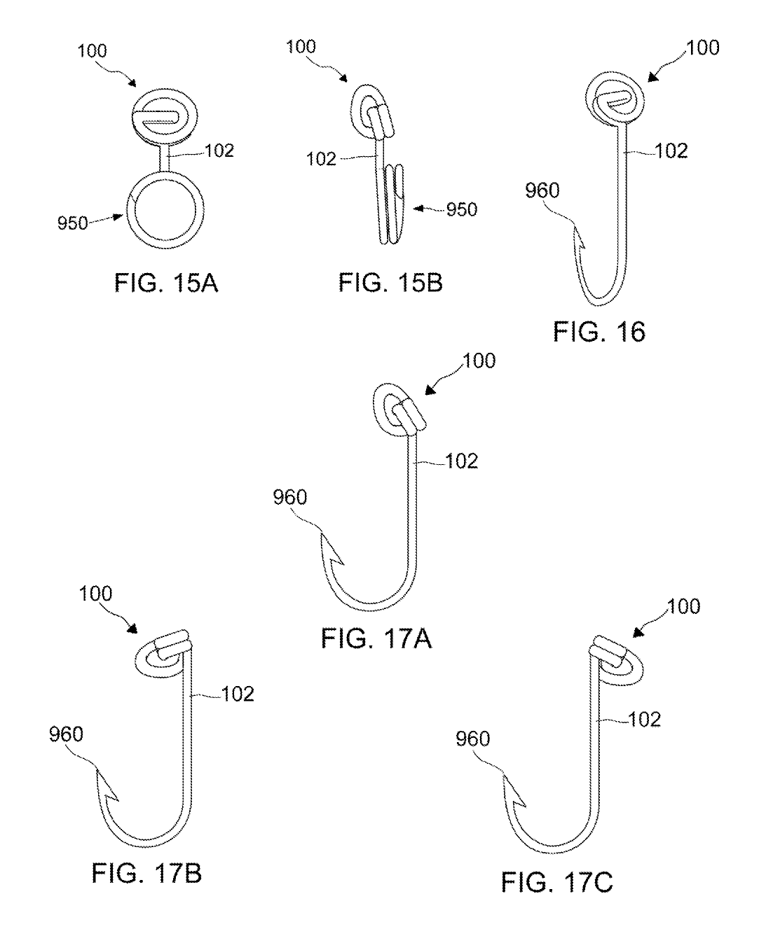

FIG. 11 shows a fishing lure that uses the non-releasable line fastening device 100. The line fastening device 100 is attached to the body of fish lure 900 by the elongated member 102. FIG. 12A shows a swivel 910 with the non-releasable line fastening device 100 at one end, and a “traditional” loop eyelet 912 at the other end. FIG. 12B is a swivel 910 that has the fastening device 100 at each end. FIG. 13 shows an interlock snap 930, adapted to integrate the non-releasable line fastening device 100. The elongated member 102 is bent to form the body of the interlock snap. FIG. 14 shows a “simple” snap 940 incorporating the device 100. FIG. 15A and FIG. 15B show a split ring 950 that has been formed at one end of the elongated member 102 of the fastening device 100. FIG. 16 shows a fishhook incorporating the fastening device 100 at the end opposite the fishhook's point 960. FIG. 17A shows a fishhook with the line fastening device 100 titled up, away from the fishhook's point 960. FIG. 17B shows a fishhook with line fastening device 100 tilted down, towards the fishhook's point 960. FIG. 17C shows a fishhook with line fastening device 100 tilted down, opposite the side of the fishhook's point 960.

### CONCLUSIONS, RAMIFICATIONS, AND SCOPE

Thus the reader will see that the non-releasable line fastening device of the present invention allows the user to quickly, easily, and securely attach a line to objects. Though the present invention will be useful in many fields; such as home improvement, climbing, safety, boating, sailing, camping, etc., the present invention will prove to be particularly useful in the field of fishing, for attaching tackle to a fishing line. The present invention's usefulness, compact design, and ability to work with any type and size fishing line makes adoption of the present invention likely. Combined with the present invention's similarity in size and looks to a “traditional” ring shaped eyelet, the present invention has overcome the barriers that have prohibited other line attachment devices from finding commercial success.

While my above description contains many specificities, these should not be construed as limitations on the scope of the invention, but rather exemplification of the preferred embodiment thereof. Many other variations are possible. For example, the present invention can be made in a variety of colors, such as gold, chrome, black, blue, etc.; the present invention can be made from a variety of stiff or semi-stiff materials, such as plastic, wood, carbon fiber, metal, etc.; the present invention can be made out of transparent plastic; the present invention can be made without an elongated member, using the point of connection between the line enclosure and object as a substitute for the elongated member.

Accordingly, the scope of the invention should be determined not by the embodiments illustrated but by the appended claims and their legal equivalents.

1. A non-releasable line fastening device comprising:
an elongated member means that allows a line to be wrapped around, and
a line enclosing means that has at least one opening, able to receive and retain a section of a line within the confines of said line enclosing means, without accessing either end of said line,
wherein:
a line with a section attached to said elongated member means, upon being pulled through the opening of said line enclosing means cannot be pulled back through the opening of said line enclosing means
whereby said line is secured to said non-releasable line fastening device.

2. The non-releasable line fastening device of claim 1 wherein said non-releasable line fastening device is made from a single piece of wire, bent to form both the elongated member means and said line enclosing means.

3. The non-releasable line fastening device of claim 2 wherein one end of said elongated member means is bent to form an article of terminal tackle.

4. The non-releasable line fastening device of claim 3 wherein said article of terminal tackle is a fishing hook.

5. The non-releasable line fastening device of claim 1 wherein said elongated member means and said line enclosing means are made from plastic.

6. The non-releasable line fastening device of claim 5 wherein a portion of said elongated member means molded from plastic being removable from an end thereof so as to reduce the size of the said non-releasable line fastening device after said line has been attached to said line attachment device.

7. The non-releasable line fastening device of claim 1 wherein said line enclosing means is attached directly to an object, thereby making the point of connection between said line enclosing means and said object, said elongated member means.

8. The non-releasable line fastening device of claim 1 wherein said non-releasable line fastening device can be attached to an eyelet or other ring-shaped line enclosure by sliding said eyelet into said line enclosing means prior to attaching said line to said non-releasable line fastening device, and upon securing a line to said non-releasable line fastening device, said eyelet will be nonreleaseably secured to said non-releasable line fastening device.

9. A line attachment device comprising:
an elongated member means that allows a line to be wrapped around, and
an interior line retaining means capable of being substantially surround by a line,
an outer guard that has zero or more openings, said outer guard surrounding all or part of said interior line restraining structure,
whereby said line can be quickly, easily, and securely attached to said line attachment device
without the use of any knots, and without access to either ends of said line.

10. The line attachment device of claim 9 wherein said line attachment device is made from a single piece of wire, bent to form both the elongated member means, said interior line retaining means and said outer guard.

11. The line attachment device of claim 10 wherein one end of said elongated member means is bent to form an article of terminal tackle.

12. The line attachment device of claim 11 wherein said article of terminal tackle is a fishing hook.

13. (canceled)

14. A method of tying a loop around an object comprising:
(a) providing a line attachment device of the type comprising an elongated member means to which a line may be wrapped around, and a line enclosing means able to receive and retain a section of a line within the confines of said line enclosing means, attached to said elongated member means, whereby said line can be quickly, easily, and securely attached to said line attachment device without the use of any knots,
(b) providing a line,
(c) providing an object,
(d) passing a portion of said line around said object, so that said line surrounds said object and said portion of said line is contiguous with the rest of said line,
whereby said line forms a loop with an open end, around said object
(e) inserting the open end of said loop into the line enclosing means of said line attachment device,
(f) wrapping the open end of said loop around the elongated member means of said line attachment device a plurality of times,
(g) inserting the open end of said loop into the line enclosing mean of said line attachment device, whereby said eyelet is secured to said flexible line, with said open end of said loop being closed and secured by said line attachment device without any knots.
